(19) United States
(12) Patent Application Publication
(10) Pub. No.: US 2016/0042168 A1
(43) Pub. Date: Feb. 11, 2016

(54) METHOD AND APPARATUS FOR AUTHENTICATING USERS

(71) Applicant: Christopher Eric HOLLAND, Fairfax, VA (US)

(72) Inventor: Christopher Eric HOLLAND, Fairfax, VA (US)

(21) Appl. No.: 14/454,274

(22) Filed: Aug. 7, 2014

(51) Int. Cl. G06F 21/34; H04L 29/06; G06F 21/32

(52) U.S. Cl. CPC G06F 21/34; G06F 21/32; H04L 63/0853; H04L 63/0861

(57) ABSTRACT

A method for authenticating users is provided that includes indicating, by a user, a desire to conduct a transaction. Moreover, the method includes monitoring, using a terminal device, for devices proximate the terminal device, and determining whether each device included in an authentication data requirement is included in proximate devices detected while monitoring for devices proximate the terminal device. Furthermore, the method includes successfully authenticating the user when each device included in the authentication data requirement is included in the detected proximate devices.

### BACKGROUND OF THE INVENTION

This invention relates generally to authenticating users, and more particularly, to a method and an apparatus for authenticating users based on device detection.

Users conduct transactions with many different entities in person and remotely over the Internet. Transactions may be network-based transactions for purchasing goods from a merchant website or may involve accessing confidential information from a website remotely over the Internet. Operators of such websites typically require successful user authentication before permitting users to conduct the transactions. During authentication, users typically interact with an authentication system to prove their claim of identity. Such interactions usually include providing user authentication data to the authentication system. However, as security requirements for conducting transactions have increased, authentication processes have become more demanding by requiring users to participate in more, and increasingly complex, interactions with authentication systems. Users typically perceive these more demanding processes as inconvenient, intrusive, and annoying. Moreover, users have been known to circumvent security requirements, for example, by creating a written copy of a password, which generally counteracts the increased security requirements. Consequently, tensions have been known to develop between users and the authenticating entities enforcing the increased security requirements.

Efforts directed at minimizing this tension, or conflict, have been known to use risk-based authentication techniques in which transactions are associated with levels of risk such as high and low levels of risk. Low risk transactions require simpler and fewer authentication interactions, while high risk transactions invoke more, and increasingly complex, interactions. The low risk interactions are perceived by users as convenient while high risk transaction interactions are perceived as inconvenient. By dividing the transactions into low and high risk transactions the number of transactions requiring inconvenient user authentication typically decreases and thus reduces tension between users and authenticating entities.

However, although known risk-based techniques reduce the number of high risk transactions requiring inconvenient user authentication, tension remains between the user and authenticating entities. As a result, transaction system efficiency decreases and costs of conducting such transactions increase.

### BRIEF DESCRIPTION OF THE INVENTION

In one aspect, a method for authenticating users is provided that includes indicating, by a user, a desire to conduct a transaction. Moreover, the method includes monitoring, using a terminal device, for devices proximate the terminal device, and determining whether each device included in an authentication data requirement is included in proximate devices detected while monitoring for devices proximate the terminal device. Furthermore, the method includes successfully authenticating the user when each device included in the authentication data requirement is included in the detected proximate devices.

In another aspect, a method for authenticating users is provided that includes requesting, by a user, to conduct a desired transaction, and monitoring, using a terminal device operated by a user, for devices owned by the user that are proximate the terminal device. Furthermore, the method includes determining whether each device included in an authentication data requirement is included in proximate devices detected while monitoring for device proximate the terminal device, and determining that the user is in a same geographic location as the detected devices when each device included in the authentication data requirement is included in the detected proximate devices.

In yet another aspect, an apparatus for authenticating users is provided that includes a processor and a memory. The apparatus is associated with a network and the memory is configured to store primary and secondary device data. Moreover, the memory is coupled to the processor and has instructions stored thereon which, when executed by the processor, causes the processor to perform operations including monitoring for devices proximate the apparatus, determining whether each device included in an authentication data requirement is included in the detected proximate devices, and successfully authenticating the user when each device included in an authentication data requirement is included in the detected proximate devices.

### BRIEF DESCRIPTION OF THE DRAWINGS

FIG. 1 is a block diagram of an exemplary terminal device for authenticating users;

FIG. 2 is a flowchart illustrating an exemplary method for authenticating users; and

FIG. 3 is a flowchart illustrating another exemplary method for authenticating users.

### DETAILED DESCRIPTION OF THE INVENTION

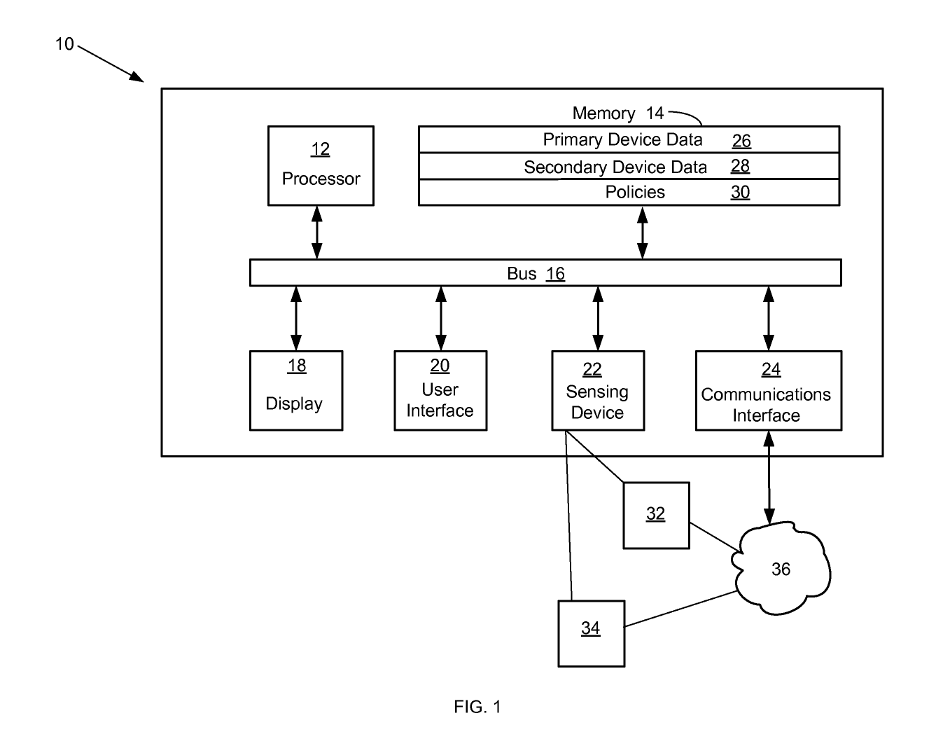

FIG. 1 is a block diagram of an exemplary terminal device 10 that may be used for authenticating users based on device detection. The exemplary terminal device 10 is a smart phone that includes at least one or more processors 12, a memory 14, a bus 16, a display 18, a user interface 20, a sensing device 22 and a communications interface 24. The terminal device 10 may alternatively be any device capable of detecting devices associated with users and processing detected data to authenticate user identities as described herein. Such alternative devices include, but are not limited to, a cellular phone, a tablet computer, a phablet computer, a laptop computer, a personal computer (PC), any type of device having wireless capabilities such as a personal digital assistant (PDA), entertainment devices, and gaming consoles. Entertainment devices include, but are not limited to, televisions. Moreover, such alternative devices may be portable or stationary. The terminal device 10 is associated with at least one user. The terminal device 10 may also capture biometric data from users.

The processor 12 executes instructions, or computer programs, stored in the memory 14. As used herein, the term processor is not limited to just those integrated circuits referred to in the art as a processor, but broadly refers to a computer, a microcontroller, a microcomputer, a programmable logic controller, an application specific integrated circuit, and any other programmable circuit capable of executing the functions described herein. The above examples are exemplary only, and are thus not intended to limit in any way the definition and/or meaning of the term “processor.” General communication between the components in the terminal device 10 is provided via the bus 16.

The memory 14 may be a computer-readable recording medium used to store data and computer programs or executable instructions. The memory 14 may include at least a primary device data portion 26, a secondary device data portion 28, and a policies portion 30. Moreover, the memory 14 may store any information that may be used to authenticate users as described herein. As used herein, the term “computer program” is intended to encompass an executable program that exists permanently or temporarily on any computer-readable recordable medium that causes the terminal device 10 to perform at least the functions described herein. Application programs, also known as applications, are computer programs stored in the memory 14. Application programs include, but are not limited to, an operating system or any special computer program that manages the relationship between application software and any suitable variety of hardware that helps to make-up a computer system or computing environment.

The memory 14 may be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), a floppy disc and disc drive, a writeable or re-writeable optical disc and disc drive, a hard drive, flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory), an optical ROM disc, such as a CD-ROM or DVD-ROM disc, and disc drive or the like. Furthermore, the memory 14 may include smart cards, SIMs or any other medium from which a computing device can read computer programs or executable instructions.

The display 18 and the user interface 20 allow interaction between a user and the terminal device 10. The display 18 may include a visual display or monitor that displays information to a user. For example, the display 18 may be a Liquid Crystal Display (LCD), active matrix display, plasma display, or cathode ray tube (CRT). The user interface 20 may include a keypad, a keyboard, a mouse, an infrared light source, a microphone, touch screen, cameras, and/or speakers. The sensing devices 22 may include RFID components or systems for receiving information regarding primary 32 and secondary devices 34. Thus, the sensing devices 22 may monitor for signals emanating from primary 32 and secondary devices 34. The sensing devices 22 may also include components with Bluetooth, Radio Frequency Identification (RFID), Near Field Communication (NFC), infrared, or other similar capabilities.

The communication interface 24 provides the terminal device 10 with two-way data communications. Moreover, the communications interface 24 enables the terminal device 10 to conduct wireless communications such as cellular telephone calls and to wirelessly access the Internet over the network 36. By way of example, the communication interface 24 may be a digital subscriber line (DSL) card or modem, an integrated services digital network (ISDN) card, a cable modem, or a telephone modem to provide a data communication connection to a corresponding type of telephone line. As another example, communication interface 24 may be a local area network (LAN) card (e.g., for Ethemet.™ or an Asynchronous Transfer Model (ATM) network) to provide a data communication connection to a compatible LAN. As yet another example, the communication interface 24 may be a wire or a cable connecting the terminal device 10 with a LAN. Thus, the communication interface 24 may facilitate wireless communications and communications over wires or cables.

Further, the communication interface 24 may include peripheral interface devices, such as a Universal Serial Bus (USB) interface, a PCMCIA (Personal Computer Memory Card International Association) interface, and the like. The communication interface 24 also allows the exchange of information across networks such as communications network 36. The exchange of information may involve the transmission of radio frequency (FR) signals through an antenna (not shown). Moreover, the exchange of information may be between the terminal device 10 and any other systems (not shown) and devices (not shown) capable of communicating over the communications network 36. Such other devices (not shown) include, but are not limited to, smart phones, tablet computers, laptop computers, phablet computers, personal computers and cellular phones. Although the terminal device 10 includes a single communication interface 24, the terminal device 10 may alternatively include multiple communication interfaces 24.

The communications network 36 is a 4G communications network. Alternatively, the communications network 36 may be any wireless network including, but not limited to, 3G, Wi-Fi, Global System for Mobile (GSM), Enhanced Data for GSM Evolution (EDGE), and any combination of a LAN, a wide area network (WAN) and the Internet. The network 36 may also be any type of wired network.

The primary device data portion 26 of the memory 14 stores data regarding primary devices 32 of a user. Primary devices 32 are personal devices belonging to a user associated with the terminal device 10 that are typically worn by the user and may be manufactured to emit signals and to otherwise communicate with other devices via Bluetooth, Near Field Communications (NFC), Radio Frequency Identification (RFID), and the like. Primary devices 32 include, but are not limited to, watches, eye-glasses, belts, and shoes. Different users typically do not wear the primary devices 32 of another user. A user will likely operate the terminal device 10 proximate his or her primary devices 32. The terminal device 10 is considered proximate a primary device 32 when the sensing device 22 is able to identify signals emanating from the primary device 32, or the sensing device 22 is able to otherwise communicate with the primary device 32. Due to the very high likelihood that the user associated with primary devices is the person wearing those devices, the proximity of primary devices 32 to the terminal device 10 may be used as the basis for authenticating users.

The secondary device data portion 28 of the memory 14 stores data regarding secondary devices of a user. Secondary devices associated with a user are generally stationary, are in an area frequented by the user, and may be manufactured to emit signals and otherwise communicate with other devices via Bluetooth, NFC, RFID, and the like. Secondary devices 34 include, but are not limited to, refrigerators, dish washers, local area network routers, ovens, and televisions. Moreover, secondary devices 34 may include any equipment or machinery, for example, a computer, that a user operates at his or her place of employment. The secondary devices are associated with a user and an area frequented by the user. The frequented area may be referred to as a geographic area. For example, the geographic area for the refrigerators, dish washers, and ovens is typically defined as the home of the user.

The terminal device 10 is considered proximate a secondary device 34 when the sensing device 22 is able to identify signals emitted from the secondary device 34 or the sensing device is able to otherwise communicate with the secondary device 34. Due to the very high likelihood that secondary devices 34 will remain stationary, the proximity of secondary devices 34 to the terminal device 10 may be used to establish a location of the user. For example, when the refrigerator, dish washer, and oven associated with a user are detected, the user is determined to be located in a geographic area defined as his or her home. The location may be used to authenticate the user and thus whether or not the user may conduct a desired transaction.

The policies portion 30 of the memory 14 stores policies for at least determining authentication data requirements. The authentication data requirement is the authentication data desired to be captured during an authentication transaction. The authentication data requirement may be any type of authentication data, or any combination of different types of authentication data and may be determined in any manner by the terminal device 10. In the exemplary embodiments described herein, the authentication data requirement is the type of device, that is, primary device 32 or secondary device 34, and a number of primary or secondary devices, respectively. The authentication data requirement may include biometric authentication data. Biometric authentication data may correspond to any biometric characteristic desired to be used as a basis of authentication such as, but not limited to, voice, face, finger, iris, palm, and electrocardiogram, and any combination of voice, face, finger, iris, palm, and electrocardiogram. Moreover, biometric authentication data may take any form such as, but not limited to, audio recordings, photographic images, and video.

In authentication transactions based on primary devices 32, the authentication data requirement may require that all primary devices for which data is stored in the primary device data portion 26 be detected, or that some of the primary devices 32 be detected. For example, when the primary devices 32 include a set of three watches only, the authentication data requirement may require detecting one of the three watches. As another example, when the primary devices include five different types of devices, the authentication data requirement may require detecting any three of the five different devices. Thus, the number of primary devices required to be detected may vary. Likewise, in authentication transactions based on secondary devices 34, the authentication data requirement may require that all secondary devices for which data is stored in the secondary device data portion 26 be detected, or that some of the secondary devices be detected. For example, when the secondary devices include a refrigerator, a dishwasher, an oven, a LAN router, and a television, the authentication data requirement may require that any three of the secondary devices 34 be detected. Fewer than all of the devices 34 may be required in order to account for secondary devices that may be broken or otherwise malfunctioning. Thus, the number of secondary devices 34 required to be detected may also vary. The authentication data requirements may be created by the user, the entity with which the user desires to conduct a transaction, or an authenticating entity. Moreover, the authentication data requirements may be different for each different desired transaction.

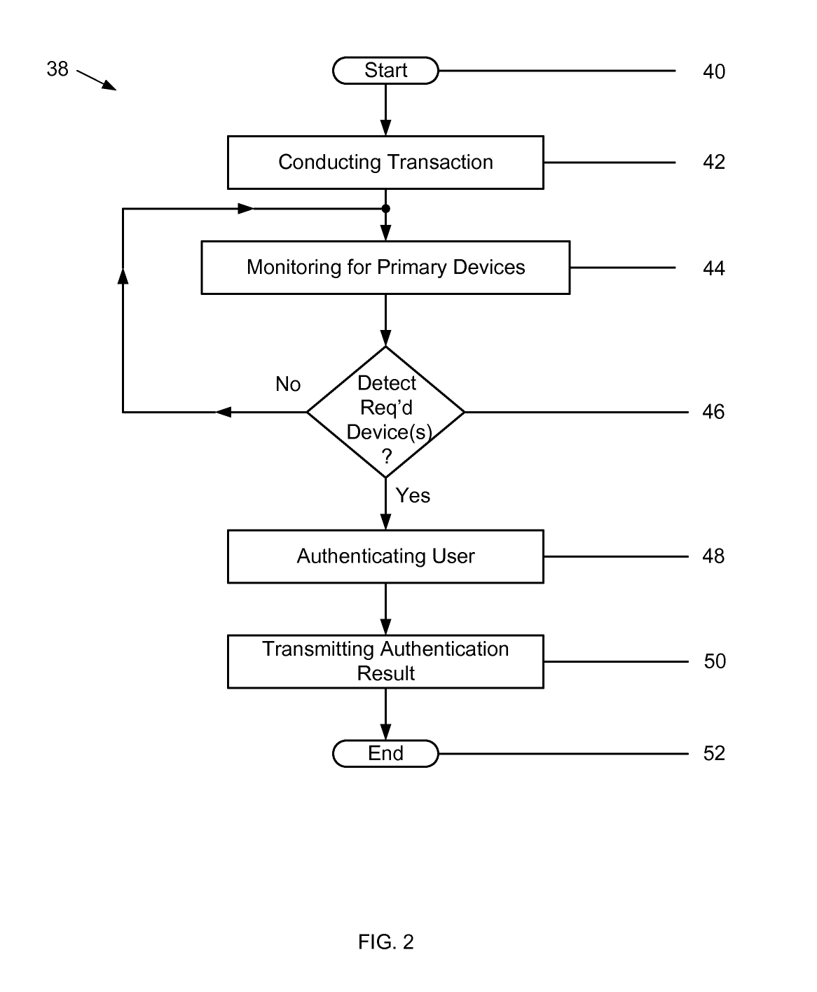

FIG. 2 is a flowchart 38 illustrating an exemplary method for authenticating a user based on device detection. The process starts 40 with a user operating the terminal device 10 indicating a desire to conduct a transaction 42 contingent upon successful authentication. The transaction may be any type for which successful user authentication may be required, for example, a network-based transaction for purchasing goods from an online merchant. Next, the terminal device 10 continues processing by automatically monitoring 44 for primary devices 32 proximate the terminal device 10 in accordance with an authentication data requirement. In this exemplary process, the authentication data requirement requires detecting one of three watches that may be worn by the user. Thus, a user is successfully authenticated when one of the three watches is detected.

Next, processing continues by determining 46 whether or not primary devices 32 in accordance with the authentication data requirement have been detected. If primary devices 32 are not detected 46 in accordance with the requirement, processing continues by monitoring 44 for primary devices in accordance with the authentication data requirement. Otherwise, when primary devices have been detected 46 in accordance with the authentication data requirement, processing continues by successfully authenticating the user 48 and transmitting 50 a successful authentication result to the merchant. Next, processing ends 52.

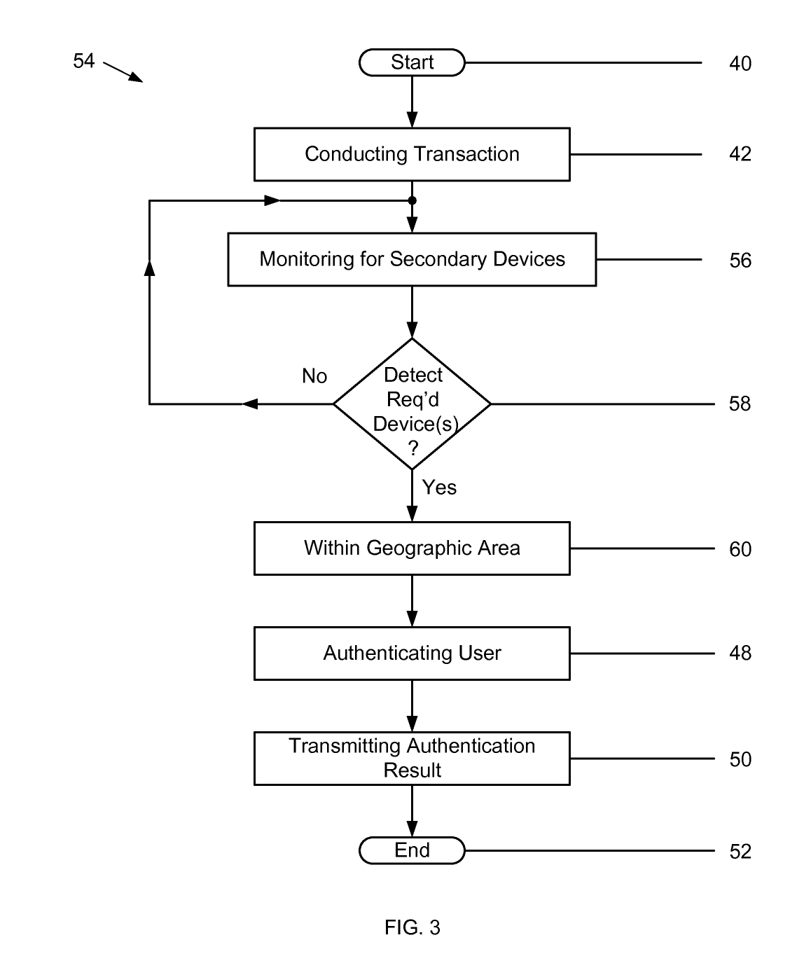

The information shown in FIG. 3 is substantially the same information shown in FIG. 2 as described in more detail below. As such, features illustrated in FIG. 3 that are identical to features illustrated in FIG. 2 are identified using the same reference numerals used in FIG. 2.

FIG. 3 is a flowchart 54 illustrating another exemplary method for authenticating users based on device detection. This exemplary process is similar to that shown in FIG. 2. However, the terminal device 10 monitors for secondary devices 34, and after determining that the user is proximate secondary devices 34 in accordance with an authentication data requirement, determines that the user is in a location defined for the detected secondary devices. More specifically, after conducting operation 42, the terminal device 10 continues processing by automatically monitoring 56 for secondary devices proximate the terminal device 10 in accordance with an authentication data requirement. In this exemplary embodiment, the authentication data requirement requires detecting three of the following five secondary devices: a refrigerator; a dish washer; an oven; a LAN router; and, a television. Each of the five secondary devices is within a geographic area defined as the house of the user.

Next, processing continues by determining 58 whether or not secondary devices 34 in accordance with the authentication data requirement have been detected. If secondary devices 34 in accordance with the requirement are not detected 58, processing continues by monitoring 56 for secondary devices 32 in accordance with the authentication data requirement. Otherwise, when secondary devices in accordance with the authentication data requirement have been detected 58, processing continues by determining that the user is in the same geographic location as the detected secondary devices, successfully authenticating the user 48, and transmitting 50 a successful authentication result to the merchant. Next, processing ends 52.

Although the determined location is used to authenticate users 48 in the other exemplary process described herein, in alternative processes the determined location may also be used to determine whether or not the user is authorized to conduct the desired transaction. Thus, after successfully authenticating the user 48, processing may continue by enforcing restrictions on the authority of the user to perform a desired transaction. Such restrictions include, but are not limited to, preventing the user from conducting a desired transaction at certain geographic locations. For example, the user may be authorized to conduct a desired transaction at his or her place of employment, but not at their home. Consequently, after being successfully authenticated 48, a user located at home may not be authorized to conduct a desired transaction which requires the user to be located in his or her place of employment while conducting the transaction.

Although the terminal device 10 automatically monitors for devices in the exemplary embodiments described herein, the user may alternatively manually operate the terminal device 10 to begin monitoring. Additionally, although the user operates the terminal device 10 to indicate a desire to conduct a transaction in the exemplary embodiments, the user may alternatively operate a different device to indicate the desire to conduct a transaction. Such different devices include, but are not limited to, a tablet computer, a laptop computer, and a personal computer. Moreover, when the user operates a different device the different device may communicate with the terminal device 10 such that the terminal device 10 automatically begins monitoring, or the user may manually operate the device 10 to begin monitoring.

The methods of authenticating users described herein may be combined with any other method of authentication to provide a multi-factor authentication transaction. Such other authentication methods include, but are not limited to, pass-phrase-based and biometric data based methods. Thus, for example, after a user is authenticated based on his or her biometric data, a terminal device 10 associated with the user may be used to authenticate the user based on device detection as described herein. Conversely, after authenticating the user based on device detection the user may be authenticated based on biometric data. In such multi-factor authentication transactions, after successfully authenticating the user for each factor the user may be permitted to conduct the desired transaction.

In each embodiment, the above-described methods and systems for authenticating users based on detected devices enhance user convenience during authentication transactions. More specifically, after a user indicates a desire to conduct a transaction, the terminal device 10 begins monitoring for primary and secondary devices. After detecting devices that satisfy an authentication data requirement, the user is authenticated and a successful authentication message is transmitted. As a result, users are not required to provide any data during authentication transactions which enhances user convenience during authentication transactions and thus facilitates reducing friction between users and authenticating entities.

The exemplary embodiments of methods for authenticating users described above should not be considered to imply a fixed order for performing the process steps. Rather, the method steps may be performed in any order that is practicable, including simultaneous performance of at least some steps. Moreover, the methods are not limited to use with the specific computer systems described herein, but rather, the methods can be utilized independently and separately from other computer components described herein. Furthermore, the invention is not limited to the embodiments of the methods described above in detail. Rather, other variations of the methods may be utilized within the spirit and scope of the claims.

1. A method for authenticating users comprising:
monitoring, using a terminal device, for devices proximate the terminal device;
determining whether each device included in an authentication data requirement is included in proximate devices detected during said monitoring step; and
successfully authenticating the user when each device included in the authentication data requirement is included in the detected proximate devices.

2. The method for authenticating users in accordance with claim 1, further comprising:
capturing biometric authentication data from the user;
authenticating the user with the captured data; and
after successfully authenticating the user, conducting said monitoring step.

3. The method for authenticating users in accordance with claim 1, further comprising:
capturing biometric authentication data from the user; and
authenticating the user with the captured data.

4. The method for authenticating users in accordance with claim 1, further comprising using a device different than the terminal device to indicate the desire to conduct a transaction.

5. The method for authenticating users comprising:
monitoring, using a terminal device operated by a user, for devices owned by the user that are proximate the terminal device;
determining whether or not each device included in an authentication data requirement is included in proximate devices detected during said monitoring step; and
determining that the user is in a same geographic location as the detected devices when each device included in the authentication data requirement is included in the detected proximate devices.

6. The method for authenticating users in accordance with claim 5 further comprising determining whether or not the user is authorized to perform the desired transaction based on the determined geographic location.

7. The method for authenticating users in accordance with claim 5, further comprising:
capturing biometric authentication data from the user;
authenticating the user with the captured data; and
after successfully authenticating the user, conducting said monitoring step.

8. The method for authenticating users in accordance with claim 5, further comprising:
capturing biometric authentication data from the user; and
authenticating the user with the captured data.

9. The method for authenticating users in accordance with claim 5, further comprising indicating, by a user, a desire to conduct a transaction using a device different than the terminal device.

10. An apparatus for authenticating users comprising;
a processor; and
a memory configured to store primary and secondary device data, said apparatus being associated with a network and said memory in communication with said processor and having instructions stored thereon which, when executed by said processor, cause said processor to perform operations comprising:
monitoring for devices proximate said apparatus;
determining whether each device included in an authentication data requirement is included in detected proximate devices; and
successfully authenticating the a user when each device included in an authentication data requirement is included in the detected proximate devices.

11. The apparatus in accordance with claim 10, wherein the operations further comprise:
capturing biometric authentication data from the user;
authenticating the user with the captured data; and
after successfully authenticating the user, monitoring for devices proximate said apparatus.

12. The apparatus in accordance with claim 10, wherein the operations further comprise:
capturing biometric authentication data from the user; and
authenticating the user with the captured data.

13. The method for authenticating users in accordance with claim 1, the authentication data requirement being at least one personal device belonging to a user.

14. The method for authenticating users in accordance with claim 5, the authentication data requirement being at least one stationary device owned by the user, the at least one stationary device being operable by the user.

15. The apparatus in accordance with claim 10, the authentication data requirement being at least one personal device belonging to a user.
